(19) United States
(12) Patent Application Publication
(10) Pub. No.: US 2005/0094188 A1
(43) Pub. Date: May 5, 2005

(54) Image transmission device and transmission data management system

(75) Inventors: Masayoshi Suzuki, Osaka (JP); Hiroaki Hase, Osaka (JP); Kiyoshi Hori, Osaka (JP)

Correspondence Address: SHINJYU GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 10/605,810

(22) Filed: Oct. 29, 2003

(51) Int. Cl. G06F 15/00

(52) U.S. Cl. 358/1.15; 358/448

(57) ABSTRACT

An image transmission device is disclosed which transmits image data to one or a plurality of devices that are capable of receiving image data, and is connected to a transmission data management computer. The image transmission device includes a transmittee data acquisition unit that acquires transmittee data, a first transmission unit that transmits image data to one or a plurality of transmittee devices as indicated by the transmittee data, and a second transmission unit that transmits transmitted image data and transmittee data to the transmission data management computer when image data is transmitted to one or a plurality of transmittee devices by the first transmission unit. A transmission data management system is also disclosed, and includes the aforementioned image transmission device, a transmission data management computer that stores data transmitted from the image transmission device, and a network that connects the image transmission device and the transmission data management computer. The transmission data management computer associates the image data transmitted from the image transmission device with the transmittee data and stores the same.

### BACKGROUND OF INVENTION

1. Field of the Invention

The present invention relates to an image transmission device such as facsimile or the like that transmits image data, and more particularly relates to the management of image data after the image data has been transmitted.

2. Background Information

Facsimile devices that read an image from an original document to generate image data, transmit the generated image data to another device via a public telephone line, receive image data from another device via the public telephone line, and output images that the image data represents are widely known in the prior art. Although a facsimile device can be used by individuals in a household, it is far more common for a facsimile device to be used by a large number of people in an office and to transmit image data to a large number of recipients (hereinafter referred to as transmittees).

In recent years, PC facsimiles comprised of a facsimile device connected to a local area network (LAN) of personal computers have grown in popularity. These PC facsimiles transmit image data from a personal computer to the facsimile device, and then transmit image data from the facsimile device to other facsimile devices via a public telephone line (see, for example, Japanese Published Patent Application No. H09-284462). When the functions of a PC facsimile are used, image data that one wants to transmit can be generated on a personal computer, and/or an image from an original document can be read and generated by an image reading device on the network. In addition, image data received from other devices via the public telephone line can be transferred to a personal computer, and images from the image data can be displayed on the personal computer and/or output to a printer on the network.

The facsimile device includes a storage device for storing both image data to be transmitted and image data received, but the image data to be transmitted will either be overwritten by other image data after it has been transmitted or will be deleted. In addition, the received image data will not be saved after it is output to paper or transferred to a personal computer.

Original documents that have been read so that images thereof can be transmitted are generally saved so that one can confirm whether or not they have been transmitted or to confirm the contents thereof that were transmitted. In particular, when a facsimile device is used in an office, original documents will in most cases be saved after they are transmitted. The task of saving these documents will be performed manually by the users.

Normally, the original documents will be classified according to the transmittee to which they were sent, but it is difficult to classify original documents that were transmitted to many different transmittees. In addition, there are times in which the same image data will be sent to a plurality of transmittees, and in this situation copies of the original documents will need to be produced in order to classify and save the original documents for each transmittee. In order to reduce this type of work, original documents are sometimes not classified but rather simply grouped together and stored. However, this makes it difficult to confirm the transmission details and/or whether or not they have been transmitted. In addition, it is difficult to organize the original documents because a comparatively large space is needed to save the original documents and because each of the original documents are not necessarily the same size.

On the other hand, when image data is transmitted by means of the PC facsimile function, the aforementioned problems related to the storage of original documents do not occur because their image data is saved on the personal computers that transmitted them. However, if there are a plurality of personal computers that have the PC facsimile function, when one wants to confirm the transmission details of the image data and/or whether or not the image data has been transmitted, one has to search each personal computer because the image data will not be stored in an organized manner thereon. In addition, if access to the personal computers is limited, then they cannot be searched at all.

Moreover, when a device combines the ability to generate image data for transmission by reading images from original documents and the PC facsimile function, then there will be a mixture of different data objects—paper original documents and electronic image data. The post-transmission management of these data objects is quite difficult.

In view of the above, there exists a need for an image transmission device and a transmission data management system which overcomes the above mentioned problems in the prior art. This invention addresses this need in the prior art as well as other needs, which will become apparent to those skilled in the art from this disclosure.

### SUMMARY OF INVENTION

An object of the present invention is to eliminate the need to store original documents after they are transmitted, and to provide an image transmission device and a computer network that can easily manage transmitted image data.

An image transmission device according to the present invention transmits image data to one or a plurality of devices that are capable of receiving image data, and is connected to a transmission data management computer. The image transmission device comprises a transmittee data acquisition unit that acquires transmittee data, a first transmission unit that transmits image data to one or a plurality of transmittee devices as indicated by the transmittee data, and a second transmission unit that transmits transmitted image data and transmittee data to the transmission data management computer when image data is transmitted to one or a plurality of transmittee devices by the first transmission unit.

In this device, when image data is transmitted to a selected transmittee device, both the image data and the transmittee data are transmitted to the transmission data management computer. Here, image data can be centrally managed by associating the image data transmitted from the image transmission device with the transmittee data and storing the same in the management computer. Even when image data to be transmitted is generated by reading an image from an original document, the need to save the original document will be eliminated.

The image transmission device is, for example, a facsimile device which reads an image from an original document, generates image data that represents the image that was read, and transmits the generated image data to another device.

A transmission data management system according to the present invention is comprised of the aforementioned image transmission device, a transmission data management computer that stores data transmitted from the image transmission device, and a network that connects the image transmission device and the transmission data management computer. The transmission data management computer associates the image data transmitted from the image transmission device with the transmittee data and stores the same.

Here, the image data and the transmittee data can be associated together and stored in various forms in the management computer. For example, the transmittee data can form a portion of the file name of the image data. In addition, the image data for each transmittee can be classified and stored based upon the transmittee data. This allows the image data for each transmittee to be easily managed. These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF DRAWINGS

Referring now to the attached drawings which form a part of this original disclosure:

FIG. 1 is a schematic diagram of the structure of a facsimile device and a computer network according to an embodiment of the present invention;

FIG. 2 is a schematic diagram of the structure of a transmittee table and a user table that is stored on a personal computer that stores image data;

FIG. 3 is a schematic diagram of the structure of folders that store image data in the aforementioned personal computer;

FIG. 4 is a flowchart showing the flow of the facsimile transmission process in the aforementioned facsimile device; and

FIG. 5 is a flowchart showing the flow of the process when data from the facsimile device is received in the aforementioned personal computer.

### DETAILED DESCRIPTION

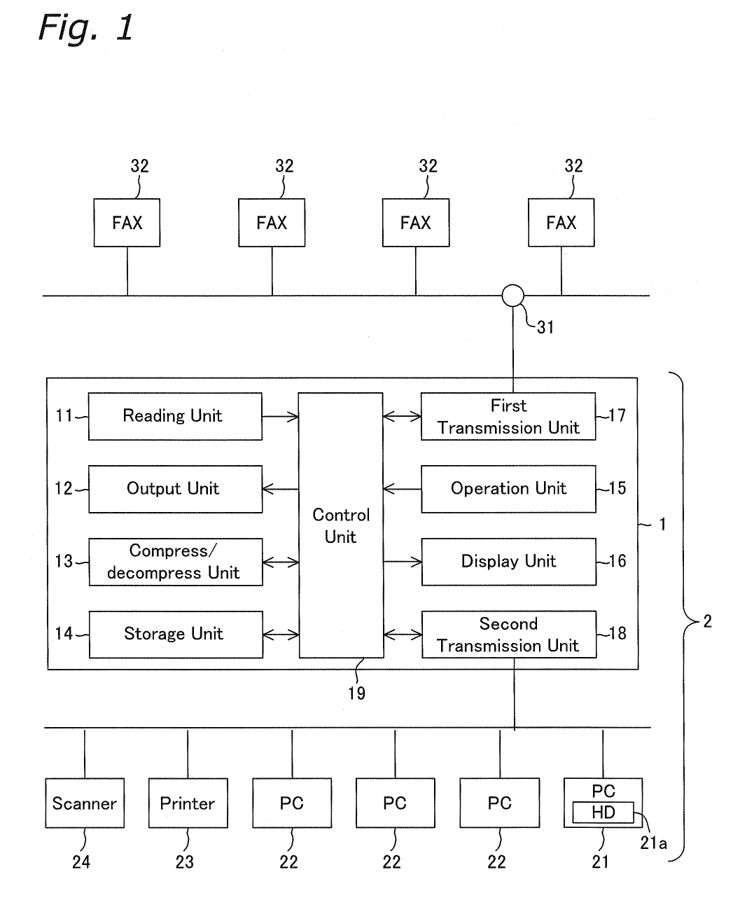

A facsimile device according to an embodiment of the present invention and a computer network that includes this facsimile device will now be described with reference to the figures. The structure of this embodiment is schematically illustrated in FIG. 1. A facsimile device 1 of this embodiment includes a reading unit 11, an output unit 12, a compress/decompress unit 13, a storage unit 14, an operation unit 15, a display unit 16, a first communication unit 17, a second communication unit 18, and a control unit 19.

The reading unit 11 reads an image from an original document, and generates image data that represents the image that was read therefrom. The output unit 12 outputs an image that the image data represents onto a sheet of paper. The compress/decompress unit 13 compresses the image data, and decompresses compressed image data. The storage unit 14 stores the image data. The operation unit 15 is operated by a user in order to input the telephone number of the transmittee to which the facsimile transmission is to be sent and to operate the facsimile device 1. The display unit 16 displays information such as the telephone number that was input and guidance on the operation of the facsimile device 1.

The first communication unit 17 is connected to other facsimile devices 32 by means of a public telephone line via an exchange 31. The second communication unit 18 is connected by means of a cable to a computer network 2 comprised of personal computers (PC) 21, 22. In addition to the facsimile device 1 and the personal computers 21, 22, a printer 23 and a scanner 24 are also included in the computer network 2.

The control unit 19 begins facsimile communication by means of the first communication unit 17, begins network communication by means of the second communication unit 18, and controls the overall operation of the facsimile device 1. When a facsimile transmission is to occur, the control unit 19 instructs the reading unit 11 to read an image from an original document, instructs the compress/decompress unit 13 to compress the image data produced by the reading unit 11, and instructs the compressed image data to be stored in the storage unit 14. Then, the control unit 19 sends the telephone number input from the operation unit 15 and the compressed image data to the first communication unit 17, and instructs the first communication unit 17 to transmit the compressed image data to the facsimile device 32 that corresponds to the telephone number that was input.

When a facsimile is to be received, the control unit 19 receives from the first communication unit 17 image data received from another facsimile device 32, and causes this image data to be stored in the storage unit 14. Then, the control unit 19 reads this image data out from the storage unit 14, causes it to be provided to the compress/decompress unit 13 to be decompressed, provides the decompressed image data to the output unit 12, and causes an image that the image data represents to be output onto a sheet of paper.

The facsimile device 1 and the personal computers 22 on the network 2 have a PC facsimile function. In other words, image data from the personal computers 22 can be transmitted to the facsimile device 1, and this image data can be transmitted to another facsimile device 32 by the first communications unit 17. This image data can be generated by the personal computers 22, or can be generated by reading an image from an original document by means of the scanner 24 on the network 2. The image data transmitted from the personal computers 22 to the facsimile device 1 will have a telephone number affixed thereto, the telephone number corresponding to one of the facsimile devices 32.

Conversely, image data received from another facsimile device 32 can also be transferred to the personal computers 22. The image data transferred from the facsimile device 1 can be freely processed in the personal computers 22. For example, image data can be displayed on the personal computers 22 as images, or the image data can be edited on the personal computers 22 by means of image data editing software. In addition, the image data can also be transmitted from the personal computers 22 to the printer 23 on the network, and the image data can be output to paper as images. Because the image data transferred from the facsimile device 1 is compressed, the image data will be decompressed in the personal computers 22 before the aforementioned processing is carried out.

When a facsimile transmission is completed, the control unit 19 of the facsimile device 1 will read the transmitted image data from the storage unit 14 and transmit it to a specific personal computer 21 on the network 2 together with the telephone number of the facsimile device 32 to which the image data was transmitted, regardless of whether the transmitted image data was generated by the reading unit 11 or whether the transmitted image data was provided from the personal computers 22. This is done in order to bundle together, save, and manage the image data transmitted by facsimile on the personal computer 21. Because the transmitted image data is saved on the personal computer 21, there is no need to save original documents after their images have been read.

In the personal computer 21, the facsimile machines 32 are distinguished from each other by means of their respective telephone numbers, and image data is classified and saved in accordance with the facsimile device 32 to which it was transmitted. This allows the saved image data to be easily managed.

In order to make management even more easy, a user of the facsimile device 1 will input an identification code provided to him or her in advance into the operation unit 15 when transmitting a facsimile. During facsimile transmission with the PC facsimile function, the identification code of the user is sent from the personal computer 22 transmitting the image data to the facsimile device 1. The control unit 19 will transmit the identification code of the user to the personal computer 21 together with the image data and telephone number.

In the personal computer 21, the user will be identified by means of the identification code, and the image data classified in accordance with the facsimile device 32 to which it was transmitted will be further classified in accordance with the user who transmitted it and then saved. In other words, the image data saved in the personal computer 21 will be classified twice.

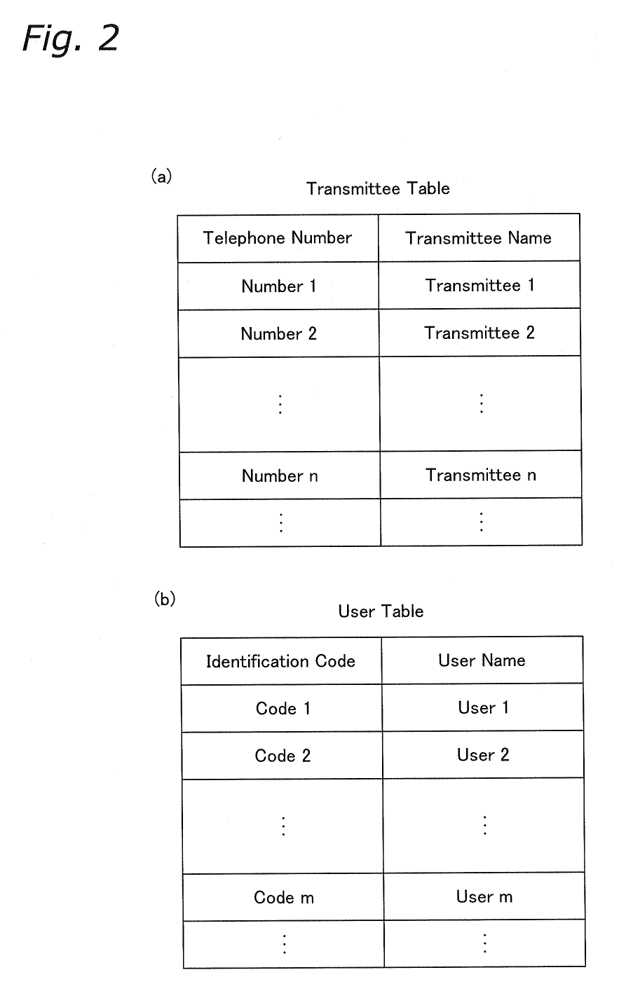

In order to store the image data, the personal computer 21 includes a high-capacity hard disk (HD). A transmittee table and a user table are stored on the hard disk 21a in order to identify the transmittees and the users. The structures of the transmittee table and the user table are respectively and schematically illustrated in FIGS. 2(a) and 2(b).

The telephone number of each facsimile device 32 is correlated with a transmittee name and stored in the transmittee table. A transmittee name is the name of the owner of a facsimile device 32, e.g., a company name, the name of a department within a company, or a person's name. When different facsimile devices 32 are owned by the same person or entity, then the same transmittee name is correlated with each respective telephone number. The identification code of a user is correlated with his or her name and stored in the user table. The same user may have two or more identification codes, and in this situation each respective identification code is correlated with the same user name and stored.

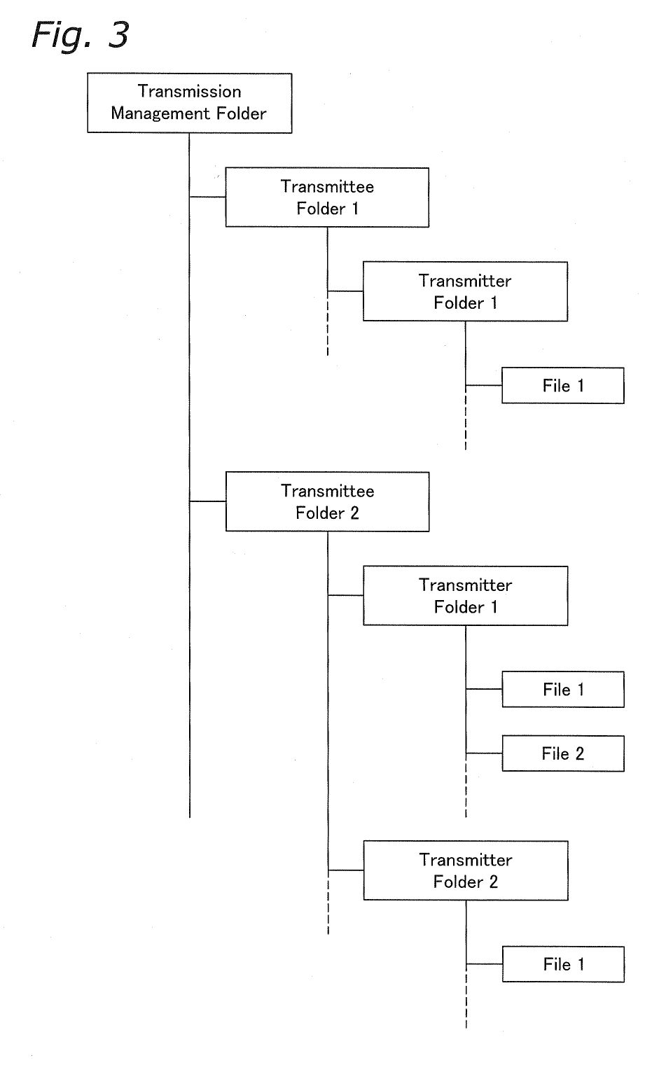

Image data is stored as individual files on the hard disk 21a, and are logically stored in files referred to as folders. The structure of the folders is schematically illustrated in FIG. 3. A transmission management folder stores all image data files, and transmittee folders provided for each transmittee are stored in the transmission management folder. In addition, transmitter folders provided for each transmitter, i.e., user, are stored in each transmittee folder. The transmittee names in FIG. 2(a) are affixed as folder names to the transmittee folders, and the user names in FIG. 2(b) are affixed as folder names to the transmitter folders. This structure allows the image data of each transmittee to be managed, and allows the image data of each transmittee to be managed according to the user who transmitted it.

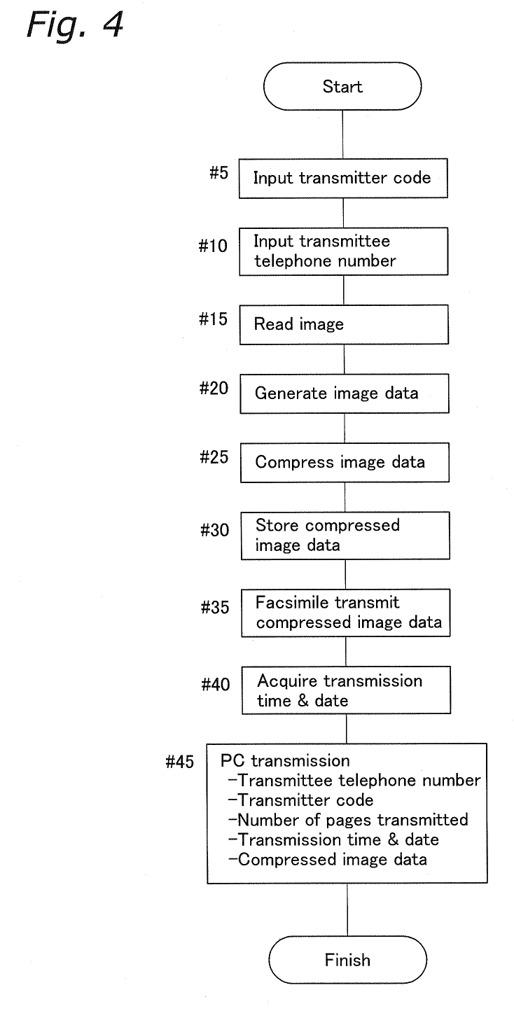

The flow of the facsimile transmission process in the facsimile device 1 is illustrated in the flowchart of FIG. 4. First, the identification code of the user and the telephone number of the transmittee are input into the operation unit 15 (Step #5, #10), and then an image is read from an original document (Step #15) and image data is generated that represents the image read out (Step #20) by the reading unit 11. Then, this image data is compressed by the compress/decompress unit 13 (Step #25), and the compressed image data is stored in the storage unit 14 (Step #30) and facsimile transmitted by the first communication unit 17 to the telephone number that was input (Step #35).

After the facsimile transmission, the transmission time is acquired by a real time clock (not shown in the figures) that is built into the control unit 19 (Step #40). Finally, the image data that was facsimile transmitted is read out from the storage unit 14, and the telephone number of the transmittee, the identification code of the user, the number of pages transmitted (number of images), and the transmission time are transmitted to the personal computer 21 by the second communication unit 18 (Step #45). When a plurality of telephone numbers are input in Step #10 and the same image data is transmitted to these plurality of telephone numbers, then all of these telephone numbers are transmitted to the personal computer 21 in Step #45.

When facsimile transmission occurs by means of the PC facsimile function, instead of processes of Steps #5 to #20 being carried out, processes will be carried out in which the identification code of the user, the telephone number of the transmittee, and the image data are received from the personal computers 22. Note that the processes of Steps #5, #10, and #15 to #30 are not limited to this sequence, and may be carried out in a random sequence. In addition, instead of inputting the telephone number of the transmittee, several transmittee names and telephone numbers may be displayed on the display unit 16 and then one can be selected from this list.

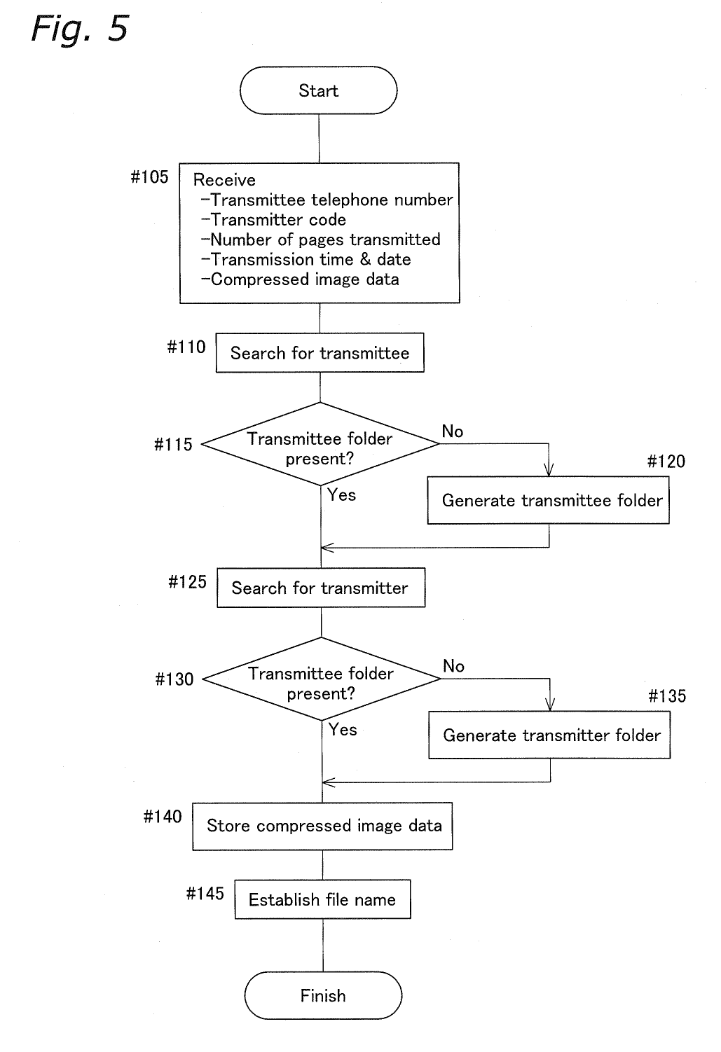

The flow of the processes carried out in the personal computer 21 in response to the transmission in Step #45 in FIG. 4 is illustrated in FIG. 5. First, the image data, the telephone number of the transmittee, the identification code of the user, the number of pages transmitted and the transmission time transmitted from the facsimile device 1 are received in the personal computer 21 (Step #105). This received data is temporarily stored in memory (not shown in the figures). Next, the transmittee table in FIG. 2(a) is searched to locate the transmittee name corresponding to the telephone number of the transmittee (Step #110), and it is then determined whether or not an transmittee folder having the transmittee name affixed thereto is inside the transmission management folder (Step #115). If there is none present, a new folder will be generated (Step #120).

Furthermore, the user table in FIG. 2(b) is searched to locate the user name corresponding to the identification code (Step #125), and it is then determined whether or not an transmitter folder having the user name affixed thereto is inside the transmitter folder (Step #130). If there is none present, a new folder will be generated (Step #135). Next, the image data received in Step #105 is stored on the hard disk 21a as a file (Step #140), and finally a file name is established for this file (Step #145).

When a plurality of telephone numbers are included in the data received from the facsimile device 1 in Step #105, the processes of Steps #110 to #120 are carried out with respect to each telephone number and the processes of Steps #130 to #145 are also carried out with respect to each telephone number. In this way, image data is individually saved in the transmittee folders corresponding to the transmittees, and the management of the image data for each transmittee is made easier.

The file name of the image file established in Step #145 includes the telephone number of the transmittee and the transmission time. For example, the file name can be in the “number-page-date-time.type” format. Here, “number” is the last 4 digits of the telephone number, “page” is the number of pages (image pages) transmitted, “date” is the year, month and day of the transmission, and “time” is the time of the transmission. In addition, “type” indicates the type (format) of the image data, such as TIF, PDF, or the like. Thus, by including the telephone number in the file name of the image data, when a facsimile transmission is made to a person or entity that owns a plurality of facsimile machines 32, it will be clear which facsimile device 32 the facsimile was transmitted to. In addition, by including the transmission time in the file name, it will be clear when the facsimile transmission was carried out.

A user can directly operate the personal computer 21 or can access the personal computer 21 via another personal computer 22 on the network 2, can look at the contents of the transmission management folder, and can display a list of the file names and the images that the image data of each file represent. A list of the file names and the images that the image data of each file represent can also be output to the printer 23 on the network 2. When a plurality of image data is included in each file, in other words, when a plurality of pages were transmitted in one transmission, the images may be reduced in size and displayed in a list (as thumbnail images) when the images are displayed or output to paper. This type of process can be easily carried out on a personal computer.

In order to maintain security, it is preferable that the contents of the transmission management folder be visible only to persons allowed to use the facsimile device 1. The identification code noted above can be used for this purpose, and when the personal computer 21 is directly operated or accessed from another personal computer 22, the user will be asked to input his or her identification code, and access to the transmission management folder will only be allowed when the correct identification code is input.

Other Embodiments

Note that in the present embodiment, an example was used in which facsimile transmitted image data will be saved in the state shown in FIG. 3. However, the image data may be saved in other ways. For example, the transmitter folders may be omitted, the image data of each file may be directly stored in the transmittee folders, or the order of the transmittee folders and the transmitter folders may be reversed and the transmittee folders may be stored in the transmitter folders. It is preferable that the storage of the image data take the number of transmittees, number of users, and other factors into consideration, and be in a state in which the image data can be managed as easily as possible.

In addition, in the present embodiment, only one facsimile device was included in the computer network, but two or more facsimile devices may be included in the computer network. Even in this situation, image data that was facsimile transmitted by each facsimile device can be centrally managed by storing the image data in one personal computer.

Furthermore, the present invention can also be applied to image data transmissions other than facsimile transmissions. For example, when image data is attached to electronic mail transmitted via the Internet, the present invention can be used to save this image data. The frequency with which image data is attached to electronic mail has increased in recent years, and the present invention is useful in the management of the image data attached to electronic mail.

When image data is transmitted to another selected device, the image transmission device of the present invention will transmit both the image data and information on that device to a specific personal computer, and the transmitted image data will be saved on the personal computer and can be flexibly and centrally managed therein. Even when image data to be transmitted is generated by reading an image from an original document, the need to save the original document will be eliminated.

Image data for each device of a transmittee can be easily managed with a computer network of the present invention that includes a personal computer that associates the aforementioned image transmission device with the image data that was transmitted by that image transmission device.

Any terms of degree used herein, such as substantially, about and approximately, mean a reasonable amount of deviation of the modified term such that the end result is not significantly changed. These terms should be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

1. An image transmission device that transmits image data to one or a plurality of devices that are capable of receiving image data and which is connected to a transmission data management computer, the image transmission device comprising:
a transmittee data acquisition unit that acquires transmittee data;
a first transmission unit that transmits image data to one or a plurality of transmittee devices indicated by the transmittee data; and
a second transmission unit that transmits transmitted image data and transmittee data to the transmission data management computer when image data is transmitted to the one or a plurality of transmittee devices by the first transmission unit.

2. The image transmission device disclosed in claim 1, further comprising a reading unit that reads images from original documents; and
the first transmission unit and the second transmission unit transmits image data read by the reading unit to the transmittee device and the transmission data management computer.

3. The image transmission device disclosed in claim 2, further comprising an operation unit for inputting the transmittee data; and
wherein the transmittee data acquisition unit acquires transmittee data that was input from the operation unit.

4. The image transmission device disclosed in claim 1, further comprising a receiving unit that receives image data from an external device that has image data; and
wherein the first transmission unit and the second transmission unit transmit image data received by the receiving unit to the transmittee device and the transmission data management computer.

5. The image transmission device disclosed in claim 4, wherein
the receiver receives image data and transmittee data from the external device; and
the transmittee data acquisition unit acquires transmittee data transmitted from the external device.

6. The image transmission device disclosed in claim 1, wherein
the one or a plurality of devices capable of receiving image data is a facsimile device; and
the first transmission unit is connected to the facsimile device via a public telephone line and an exchange.

7. The image transmission device disclosed in claim 1, wherein
the external device is at least one selected from the group consisting of a computer, a printer, and a scanner; and
the receiving unit is connected to at least one of the computer, printer, and scanner via a network.

8. The image transmission device disclosed in claim 1, wherein the first transmission unit transmits image data, transmittee data, and transmitter data to the transmission data management computer.

9. A transmission data management system, comprising:
an image transmission device;
a transmission data management computer that stores data transmitted from the image transmission device; and
a network that connects the image transmission device and the transmission data management computer;
wherein the image transmission device comprises:
a transmittee data acquisition unit that acquires transmittee data;
a first transmission unit that transmits image data to one or a plurality of transmittee devices indicated by the transmittee data; and
a second transmission unit that transmits transmitted image data and transmittee data to the transmission data management computer when image data is transmitted to the one or a plurality of transmittee devices by the first transmission unit; and
the transmission data management computer associates the image data transmitted from the image transmission device with the transmittee data and stores the same.

10. The transmission data management system disclosed in claim 9, wherein the transmission data management computer classifies and stores image data for each transmittee based upon the transmittee data.

11. The transmission data management system disclosed in claim 10, wherein the first transmission unit of the image transmission device transmits image data, transmittee data, and transmitter data to the transmission data management computer; and
the transmission data management computer classifies and stores image data for each transmittee and each transmitter.
